(19) United States
(12) Patent Application Publication
(10) Pub. No.: US 2001/0013228 A1
(43) Pub. Date: Aug. 16, 2001

(54) Beverage cooler

(76) Inventor: Sam Chiusolo, Ontario (CA)

Correspondence Address: BIRCH STEWART KOLASCH & BIRCH, PO BOX 747, FALLS CHURCH, VA, 22040-0747, US

(21) Appl. No.: 09/764,441

(22) Filed: Jan. 19, 2001

(30) Foreign Application Priority Data
Jan. 20, 2000 (CA) 2296579

(51) Int. Cl. B67D 5/62

(52) U.S. Cl. 62/389

(57) ABSTRACT

The apparatus comprises a container for a carbonated beverage and a pressure tank for maintaining the beverage under pressure in the container. Beverage from the container flows through a coil and then to a tap from which it is discharged, The coil is mounted in a cooler where the beverage is cooled to a temperature in the range of about 30 degrees F. and about 32 degrees F. The coil has an entry point at which the beverage enters the coil, an upstream segment and a downstream segment. The upstream segment has an inner diameter in the range of about 5/16 inch to about ¼ inch and the downstream segment has an inner diameter of about 3/16 inch and a length of not less than about 3 feet.

### BACKGROUND OF THE INVENTION

This invention relates to apparatus for cooling beverages and more particularly to a portable cooler having provision for reducing or eliminating the formation of foam in carbonated beverages.

Portable coolers which dispense beverages are often seen in such places as golf courses and concession stands. On golf courses for example coolers are often mounted on trailers towed by golf carts. The coolers usually contain beer but sometimes contain soft drinks. At concession stands the coolers are usually mounted in trucks and contain soft drinks.

A problem which is encountered in portable coolers which dispense carbonated beverages is excessive foaming of the product. Portable containers are often subject to severe agitation when they are travelling over hilly or rough terrain such as golf courses. Such agitation causes the beverages to combine with gases in which they are in contact to form foam. If the beverage is beer, the beer which discharges from the container will be in the form of foam. In this state, the beer is entirely unacceptable.

### SUMMARY OF THE INVENTION

I have found that foaming of carbonated beverages in a portable cooler can be reduced considerably, if not entirely eliminated, by control over the conditions in which the beverages are cooled. For example the dimensions of the apparatus in which the beverages are cooled, the temperature and pressure of the beverages during cooling all have an influence over the extent to which foam-producing gases combine with the beverages. If these conditions are controlled, foam can be reduced or, in some cases, entirely eliminated.

The apparatus of my invention, in one embodiment, includes a container for a beverage; means for maintaining the beverage under pressure in the container; a conduit in liquid flow communication with the container; and a tap downstream of the conduit through which cooled beverage discharges from the apparatus. The apparatus includes a cooler having an inner wall which defines a space within which the conduit is mounted. A vessel is mounted within the space and surrounds the conduit. The vessel has an outer wall spaced apart from an inner wall of the cooler and has perforations formed therein. The cooler is adapted to have cooling fluid circulating therein. The fluid is partly in a liquid state which passes thorough the perforations and circulates around the conduit and partly in a solid state substantially of a size too large to penetrate the perforations. The solid particles are adapted to be located substantially in the portion of the space between the inner wall of the cooler and the outer wall of the vessel. Means is provided for maintaining the cooling fluid in circulation.

Another embodiment of my apparatus, specifically for the cooling of beer, comprises a container for beer; means for maintaining the beer under pressure in the container; a coil in liquid-flow communication with the container; a tap downstream of the coil through which cooled beer discharges from the coil; and cooling means for cooling the beer flowing through the coil to a temperature in the range of about 30 degrees F. and about 32 degrees F. The coil has an entry point at which the beer enters the coil, an upstream portion and a downstream portion, the upstream portion having an inner diameter in the range of about 5/16 inch to about ¼ inch and the downstream portion having an inner diameter of about 3/16 inch, the downstream portion having a length of not less than about 3 feet.

### DESCRIPTION OF THE DRAWINGS

The invention is described with reference to the accompanying drawings in which:

FIG. 1 is a perspective view of the apparatus mounted on a trailer;

FIG. 2 is a perspective view, partly cut away, of the cooling coil of the apparatus;

FIG. 3 is a side view, cut away and in enlarged scale, of a portion of the cooling coil;

FIG. 4 is a cross-section of the coil.

Like reference characters refer to like parts throughout the description of the drawings.

### DESCRIPTION OF PREFERRED EMBODIMENTS

The description which follows is of an apparatus for cooling and dispensing beer but it is to be understood that the apparatus of the invention is not limited to one for cooling and dispensing beer. The apparatus can be used to cool and dispense other carbonated beverages such as non-alcoholic and alcoholic drinks. The apparatus can for example be used to dispense carbonated soft drinks and spritzers.

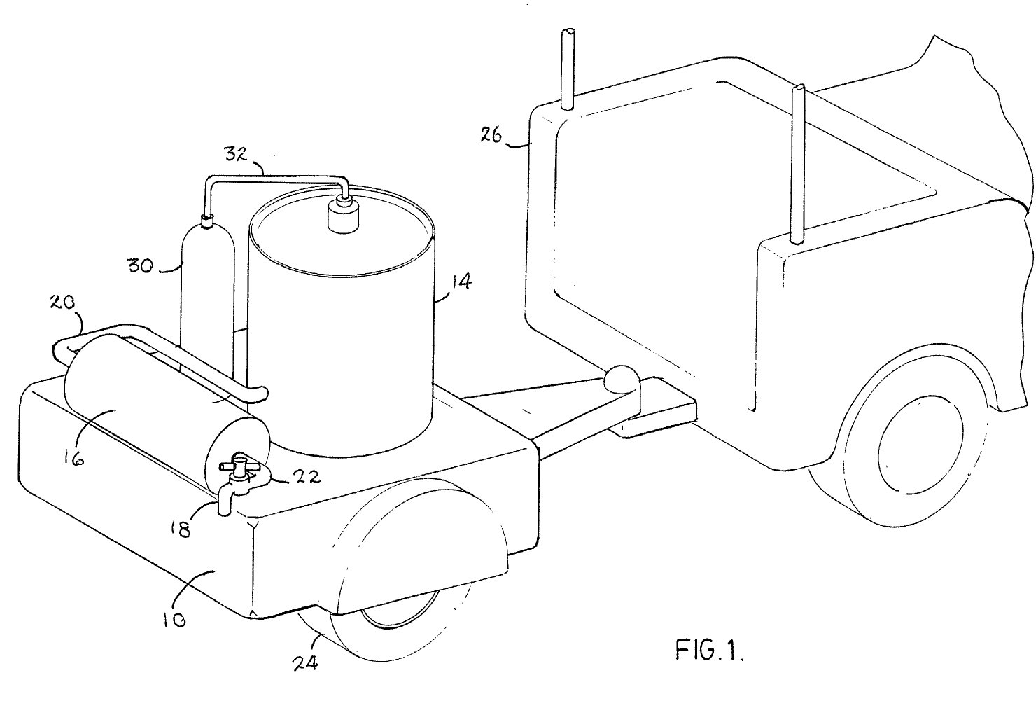

With reference to FIG. 1, a trailer 10 holds a keg 14, a cooler 16 and a tap 18 from which beverage within the keg and cooler discharge. The keg contains beer which flows through a hose 20 to the cooler where it is chilled. From the cooler, the beer flows through a second hose 22 to the tap 18 from which it discharges. Preferably hoses 20 and 22 are composed of braided polyvinyl chloride.

The trailer 10 is mounted on wheels 24 so that it can be towed by a motorized golf cart 26. The keg may be removed from the trailer when it is empty and replaced by another full keg.

Beer within the keg is maintained under pressure by means of so called “beer gas” stored in a conventional pneumatic or gas cylinder 30. Beer gas is usually composed of from about 65 to 75 percent nitrogen and the remainder carbon dioxide. The gas is introduced into the interior of the keg through a hose 32 which extends from the cylinder to the keg. A nozzle and pressure gauge (not illustrated) both of conventional construction are provided in the gas line so that the pressure within the keg can be monitored and controlled.

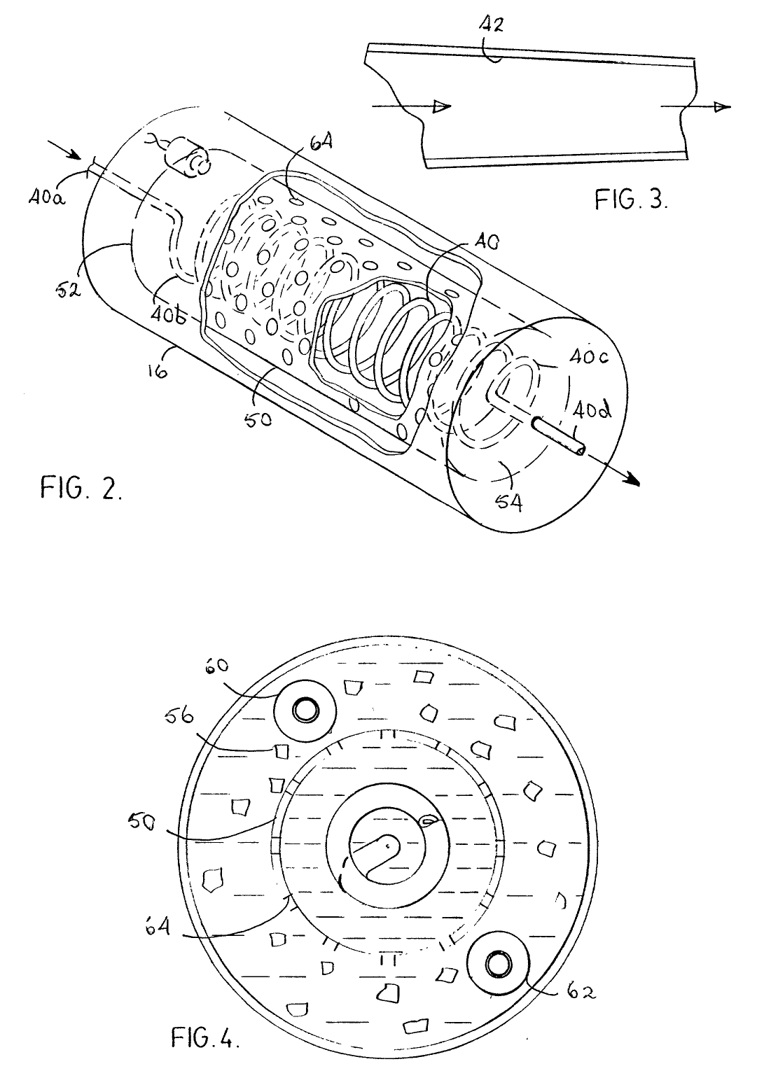

With reference to FIGS. 2 and 3 a conduit or coil 40 extends through the cooler 16. The coil has a point of entry 40a at which beer enters the coil. From the point of entry, the beer enters an upstream segment 40b and from the upstream segment the beer flows to a downstream segment 40c.

The inner diameter of the coil decreases downstream of the flow of beer. In FIG. 3 the inner wall 42 of the coil diminishes gradually but the decrease may be abrupt. In the latter event, the inner diameter of the upstream segment is greater than that of the downstream segment. The two segments may be interconnected by a joint of conventional construction.

Preferably, the two segments of the coil are composed of stainless steel and each has a constant inner diameter. The inner diameter of the coil at the point of entry 40a is about ⅜ inch as is that of hose 20 through which the beer flows to the cooler from the keg.

The upstream segment 40b has an inner diameter of about ¼ inch while the downstream segment has an inner diameter of 3/16 inch.

The upstream segment should about 60 to about 70 feet in length measured along the longitudinal axis of the coil. Any shorter than 60 feet and the volume of beer at the desired temperature will diminish while any longer than 70 feet, while permissible, will necessitate a higher pressure of beer gas to cause the beer to flow at a satisfactory rate. The preferred pressure of beer gas is about 45 to 55 psi and if the pressure is increased above this range, the allowable upper limit of pressure within the keg may be exceeded. Typically the allowable limit is about 60 psi.

The downstream segment should be about 3 feet in length measured along the longitudinal axis of the coil. Significantly longer and the flow of beer will diminish to a trickle and significantly shorter and foaming becomes a problem.

The downstream segment terminates at the tap and accordingly it will straighten as at 40d at its downstream end. While it is desirable that the downstream segment be substantially entirely within the cooler, the apparatus will still work if the downstream segment is partly within and partly outside the cooler.

With reference to FIGS. 2 and 4, the coil is mounted within a perforated vessel or cylinder 50 which is closed at both ends 52, 54. The cylinder is mounted within cooler 16 which has solid sides and end walls.

The cooler contains water and particles of ice 56 which serve to cool the beer within the coil. A drain (not illustrated) is provided at the bottom of the cooler through which the water can be drawn off. A faucet (not illustrated) is provided in the discharge line for controlling the flow from the drain.

An opening (not illustrated) is formed on the top of cooler for admission of fresh water and ice particles. The opening is closed by a lid (not illustrated) for preventing the contents of the vessel from spilling out when the trailer is moving.

Two submersible pumps 60,62 are mounted within the vessel to cause the water to circulate. The water circulates freely around the pumps but the ice particles are prevented from contacting and damaging the pump because they are too large to penetrate through the perforations 64 in cylinder 50.

A pump suitable for causing the water and ice particles to circulate is submersible pump model V500 no. 4204 sold by Attwood Company. The pump is powered by a 12 volt battery which delivers 1.5 amperes current. The battery is mounted on the trailer so that the trailer is completely portable and self-contained.

With reference to FIG. 1, cooled beer flows from the coil to tap 18. The tap is of conventional construction and is spring-loaded closed. Such a tap ensures that pressure within the line through which beer flows is maintained at the desired value at all times except when the tap is opened to dispense beer.

The beer cooler described above is capable of cooling beer from ambient temperature to a temperature in the range of about 32 to about 34 degrees F. This is the range generally favoured by most consumers of beer brewed in North America. Thus the temperature of the beer in the keg will be ambient while the temperature at tap 18 will be about 32 to about 34 degrees.

The conditions which have an effect on the amount of foam which discharges from the tap are as follows:

1. The pressure of gas within the keg. The pressure should be maintained at about 45 to 55 psi preferably 47 psi. The gauge which measures the pressure within the keg should be monitored to ensure that the pressure remains within this range. It is believed that if the pressure is below this range, carbon dioxide in the beer comes out of solution and combines with beer as foam. If the pressure is above this range, the keg must be constructed of heavier and stronger material at added cost and with no significant benefit.

2. The inner diameter of the coil. The diameter must decrease as the beer flows downstream. As indicated above the inner diameter of the coil at the point of entry into the perforated cylinder 50 should preferably be about ¼ inch and at the point of exit from the cylinder about 3/16 inch.

3. The length of the coil. The upstream segment should be over about 60 feet long and less than about 70 feet. The downstream segment should be about 3 feet long.

It should be noted that the cooler of the subject invention may be used to cool any carbonated beverage and may be stationary as well as mobile. The drawings and description are intended to be illustrative of one way in which the subject invention may be put into practice. They are not intended however to limit the scope of the invention.

I claim:

1. An apparatus for cooling a beverage comprising: a container for said beverage; means for maintaining said beverage under pressure in said container; a conduit in liquid flow communication with said container; a tap downstream of said conduit through which beverage discharges from said apparatus; a cooler having an inner wall which defines a space within which said conduit is mounted; a vessel mounted within said space and surrounding said conduit, said vessel having an outer wall spaced apart from an inner wall of said cooler and having perforations formed therein, said cooler adapted to have cooling fluid circulating therein, said fluid being partly in a liquid state which passes thorough said perforations and circulates around said conduit and partly in a solid state substantially of a size too large to penetrate said perforations and adapted to be located substantially in the portion of said space between the inner wall of said cooler and the outer wall of said vessel; and means for maintaining said cooling fluid in circulation.

2. The apparatus as claimed in claim 1 wherein said conduit has an inner diameter which diminishes downstream of the flow of said beverage.

3. The apparatus as claimed in claim 1 wherein said conduit is composed of upstream and downstream segments, the inner diameter of said upstream segment being greater than the inner diameter of said downstream segment.

4. The apparatus as claimed in claim 1 wherein said tap is spring-loaded closed to ensure that pressure within said conduit is maintained at all times except when the tap is opened to dispense said beverage.

5. The apparatus as claimed in claim 1 wherein the pressure of said beverage within said container is maintained in the range of about 45 to 55 p.s.i.

6. The apparatus as claimed in claim 1 wherein the pressure of said beverage within said container is maintained at about 47 p.s.i.

7. The apparatus as claimed in claim 1 wherein said conduit has an inner diameter which at the point at which said beverage enters said conduit is about ⅜ inch and the point at which said beverage exits therefrom is about 3/16 inch.

8. The apparatus as claimed in claim 1 wherein said conduit is at least about 65 feet in length.

9. An apparatus for cooling beer comprising: a container for said beer; means for maintaining said beer under pressure in said container; a coil in liquid-flow communication with said container; a tap downstream of said coil through which beer discharges from said coil; and cooling means for cooling said beer flowing through said coil to a temperature in the range of about 30 degrees F. and about 32 degrees F., said coil having an entry point at which said beer enters said coil, an upstream segment and a downstream segment, said upstream segment having an inner diameter in the range of about 5/16 to about ¼ inch and said downstream segment having an inner diameter of about 3/16 inch, said downstream portion having a length of not less than about 3 feet.

10. The apparatus as claimed in claim 9 wherein said upstream segment has a length in the range of about 60 feet to about 70 feet

11. The apparatus as claimed in claim 10 wherein the inner diameter of said coil at the point of entry is about ⅜th inch.

12. The apparatus as claimed in claim 11 wherein the inner diameter of said upstream segment is about ¼ inch.

13. The apparatus as claimed in claim 12 wherein the pressure of beer within said container is in the range of about 45 psi and about 60 psi.

14. The apparatus as claimed in claim 12 wherein the pressure of beer within said container is about 47 psi.

15. The apparatus as claimed in claim 9 further including: a cooler within which said coil is mounted; a vessel mounted within said cooler and surrounding said coil, said vessel having an outer wall spaced apart from an inner wall of said cooler, said outer wall having a plurality of perforations formed therein, said cooling means being cooling fluid circulating throughout said cooler, said fluid being partly in a liquid state which passes thorough said perforations and circulates around said coil and partly in a solid state substantially of a size too large to penetrate said perforations and being located substantially in the space between the inner wall of said cooler and the outer wall of said vessel.

16. The apparatus as claimed in claim 15 further including means for maintaining said cooling fluid in circulation, said means being located within said vessel.

17. The apparatus as claimed in claim 16 wherein said fluid is water, partly in the form of liquid water and partly as ice.
